(19) United States
(12) Patent Application Publication
(10) Pub. No.: US 2008/0295090 A1
(43) Pub. Date: Nov. 27, 2008

(54) SOFTWARE CONFIGURATION MANAGER

(75) Inventors: Edward Bestle, Owego, NY (US); Stephen J. DeMarco, Binghamton, NY (US); Andrew T. Dodd, Owego, NY (US); John M. Gregory, Vestal, NY (US); Victor Harper, Endicott, NY (US); Christian S. McPhail, Owego, NY (US); Thomas T. Mix, Vestal, NY (US); David R. Paige, Vestal, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/124,829

(22) Filed: May 21, 2008

Related U.S. Application Data
(60) Provisional application No. 60/931,690, filed on May 24, 2007.

(51) Int. Cl. G06F 9/44

(52) U.S. Cl. 717/170

(57) ABSTRACT

A system configuration process is implemented to verify that each component implemented in a processing system is compatible and includes the appropriate software version. Electronic modules or components of the system are queried as part of a pre-operation check for their installed software version data. The verification is completed by comparing the software version data to a system configuration definition that is permanently stored in system memory. A user can query the components as components are added, removed or upgraded, to verify that the system's actual configuration corresponds to that of the system configuration definition.

### RELATED APPLICATION

This application claims priority to U.S. Provisional Patent Application Ser. No. 60/931,690 filed on May 24, 2007, the entire content of which is incorporated herein by reference.

### BACKGROUND

Control systems for a variety of applications can be composed of many electronic components, including numerous computational and control devices that include non-volatile software programs. All of these electronic components must interface and interact with each other for the system to function correctly. In some cases, a verification process is implemented to ensure that each item of software has been tested to verify that the components work properly with each other. Once a system is verified through testing, a document is produced listing the valid software version numbers for a specific system configuration. This document must be manually checked against each of the components installed in the system from time-to-time. If the components of the control systems do not satisfy the verified restraints of the system configuration numerous problems may be created. This problem is particularly acute in complex software systems having components that are continually being upgraded or replaced, such as aircraft avionics, manufacturing control systems, business financial systems, and the like.

### SUMMARY

According to one embodiment of the invention, a system configuration process is implemented to verify that each component implemented in the system is compatible and includes the appropriate software version. The verification is completed by comparing the components installed in the system to a system configuration definition that is permanently stored or “imprinted” within a memory.

In another embodiment of the invention, a system configuration definition is integrated with software in a system, as well as on one or more external computers. This allows the actual component software version numbers to be queried by a user as part of a pre-operation check. Additionally, a user can query the component software revision numbers as components are added or removed from the system, thereby verifying that the system's configuration is correct and operable.

In another embodiment of the invention, a system configuration process that includes a system configuration definition is integrated with avionics control software on an aircraft. The system configuration definition can also be stored in a maintainer's computer. This allows the actual set component software version numbers to be queried by a pilot as part of a pre-flight check, so that any incompatibilities are discovered before the flight. Additionally, the maintainer can query the component software revision numbers as components are added or removed from the aircraft avionics, thereby verifying that the aircraft's system configuration is correct and flyable.

In yet another embodiment, after software version numbers are queried, the results of the query are returned to a user (e.g., a pilot, maintainer, or system administrator). If the system configuration is incorrect, the querying software reports the incompatible components so that they can be corrected. After the correction, the system configuration can be queried again to verify that a proper system configuration has been achieved.

Other aspects of the invention will become apparent by consideration of the detailed description and accompanying drawings.

### BRIEF DESCRIPTION OF THE DRAWINGS

FIG. 1 illustrates a system configuration management process according to an embodiment of the invention.

FIG. 2 illustrates a system configuration utility according to an embodiment of the invention.

FIG. 3 illustrates a software loader application according to an embodiment of the invention.

FIG. 4 illustrates a relationship between the system configuration utility shown in FIG. 2 and the software loader application shown in FIG. 3, according to an embodiment of the invention.

FIG. 5 illustrates a truth or look-up table that can be implemented in the system configuration management process shown in FIG. 1.

FIG. 6 illustrates a relationship between a variety of “users” and a system configuration management process according to an embodiment of the present invention.

FIG. 7 illustrates a diagnostic tool that can be used to diagnose and provide maintenance instructions for an aircraft.

FIG. 8 illustrates a flight screen displaying a system configuration resulting from a system configuration management system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “upported,” and “coupled” and variations thereof are used broadly and encompass both direct and indirect mountings, connections, supports, and couplings. Further, “connected” and “coupled” are not restricted to physical or mechanical connections or couplings.

Electronic components are increasingly being used to control functions in a variety of settings. For example, many air, land, and sea vehicles employ a multitude of electronic components to control a plurality of functions (e.g., navigation, maneuvering, power, weapons, etc.). Additionally, other arenas, such as manufacturing, heavy equipment, chemical processing, business management systems, etc., may utilize a variety of electronic components to control functions. These and other complex systems often have separate software modules supplied by different manufacturers that are regularly modified, upgraded and replaced.

The electronic components (and the software implemented by these electronic components) are often tested individually and as sub-assemblies to ensure proper operation, as well as compatibility with each other. For example, a certain application that requires the use of several different types of components (each of which may include several versions of software) are tested as an assembly to ensure that each of the components operate properly, and that the software being implemented by the components are compatible with each other. In some embodiments, as described in greater detail below, this testing process is referred to as a product test verification (“PTV”).

The illustrative embodiments of the invention described below generally relate to an aircraft. More specifically, the embodiments described herein relate to an aircraft having one or more removable, replaceable, and/or interchangeable electronic components (referred to generally as line replaceable units (“LRU”) or weapon replaceable assemblies (“WRA”)). These components commonly contain non-volatile memory that can be supplied or “loaded” with software which is used to control a variety of functions of the aircraft (e.g., a radar system, a guidance system, a weapons system, a targeting system, a pilot interface system, etc.). However, as should be apparent to one of ordinary skill in the art, embodiments of the invention may also be adapted to a variety of other vehicles and/or systems, such as factory manufacturing systems, business management, financial and accounting systems, chemical, pharmaceutical and biopharmaceutical processing systems, equipment or patient monitoring systems, complex security systems, trucks and other large vehicles, mining and mineral exploration equipment, power plants, food processing plants, spacecraft, sorting systems, and any other systems having software components whose compatibility is desirable.

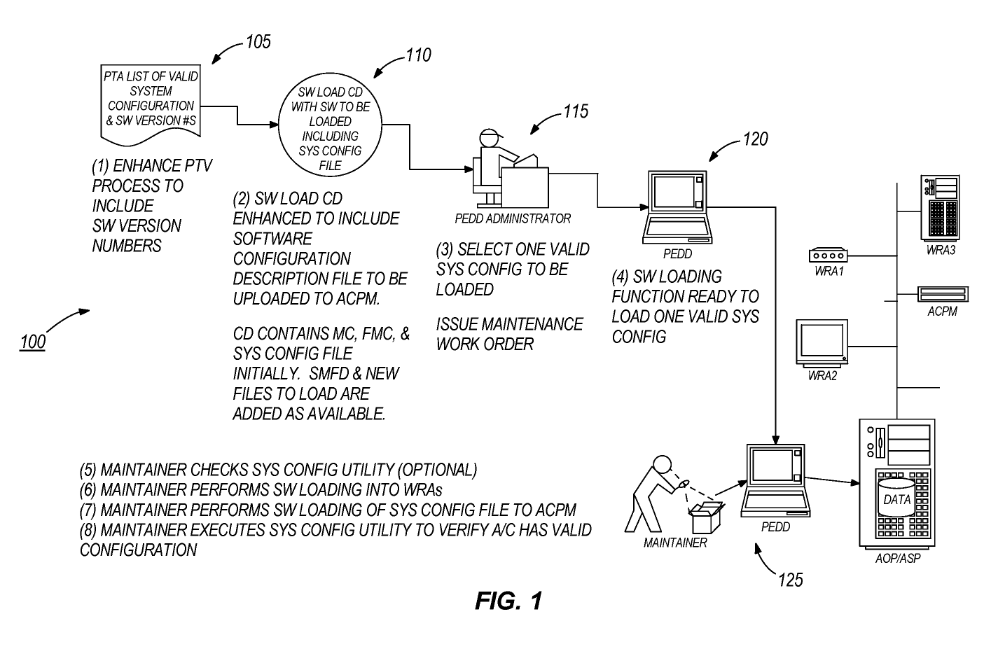

FIG. 1 illustrates a system configuration management process 100 according to an embodiment of the invention. Generally, the system configuration management process 100 can be used to ensure that a particular system configuration (e.g., a combination of electronic components and associated software) is operable and/or valid for a vehicle or other system having one or more installed electronic components. In some embodiments, the system configuration management process 100 can be used to manage a system configuration of an aircraft.

For example, some modern aircraft are multi-purpose with removable and replaceable components (e.g., WRAs) to serve different missions. A basic mission might be search and rescue, while a more advanced mission might be armed search and rescue. Another mission may include armed interdiction. Aircraft mechanics and technicians (“maintainers”) can remove components or add components to customize the configuration of the aircraft to the mission that is being carried out. This customization is done as needed, perhaps during military actions. All of the components assembled on the aircraft for a particular mission need to operate correctly with a certain system configuration. Additionally, over the lifetime of an aircraft, components may become obsolete and be replaced by components with additional functionality. Many components' software may also be upgraded. Components may also be removed and shared between different aircraft of a fleet. Thus, prior to releasing the aircraft for use, a PTV is completed to ensure that all of the components and associated software revisions and/or versions operate properly with one another. The result of a PTV is a document (or electronic file) that provides a listing of all of the components and associated software that is authorized to be used in the aircraft. For example, a PTV can include data related to the type of component that is authorized to be installed, as well as the software revision(s) that are authorized to be used. If a certain component has multiple different valid software revisions (e.g., revision 3.1, 3.12, 3.2, etc.), each of those revisions is listed in the PTV.

As components are replaced, revised, and/or upgraded, the system configuration can be maintained using the system configuration management process 100. The first step in the process 100 is to implement a PTV process that includes testing software version numbers (step 105). For example, in addition to testing each of the components (e.g., WRAs) that may be installed in the aircraft, each software (the software corresponding to the components) revision is tested. This is done to ensure that a particular set of components includes software versions that has been tested to operate properly with software of other components, and has been certified for flight. As described above, aircraft may change from one configuration to another, and include one or more components that are replaceable with other components having different versions of software and/or hardware. Additionally, software upgrades may occur over the life of the aircraft. There are also a variety of different vendors that may provide components and subsystems, which results in the components having multiple software version numbers. Different vendors may also be supplying the same components. Additionally, several versions of software may be valid or allowed for a single component. Such circumstances leads to an extensive PTV process that includes the testing of valid software versions for each of the components that may be installed in the aircraft.

The PTV process can be used while creating system configuration definitions (“SCD”). For example, SCDs, which can be identified by a name and/or number (e.g., system configuration 54.2), can be created to carry out certain tasks, and include certain sets of components to perform those tasks. For example, an SCD that is created for a search and rescue mission may include a specific set of WRAs that are installed in the aircraft. Accordingly, the SCDs can include a listing of each component that is allowed to be installed on the aircraft and the corresponding valid software revision number(s) that are implemented by that component. For a particular aircraft, there may be multiple valid SCD, for example, to accommodate system configurations that include different combinations of WRAs.

Referring again to FIG. 1, after the PTV process has been enhanced to include software version numbers, a software load component (e.g., a CD, a DVD, a flash memory drive, etc.) can be created, which includes one or more software configuration description files (“SCDF”) in addition to various software that is loaded into the WRAs (step 110). An SCDF is a software file that represents a particular SCD (as described above) for the aircraft. For example, the SCDF can include data (e.g., make, model number, software version numbers, etc.) for each WRA for a particular system configuration. In some embodiments, the SCDF includes a “truth table” or look-up table that provides a plurality of relevant WRA data (see, for example, the table shown in FIG. 5). The SCDF is generated during the PTV process, thereby ensuring a one-to-one correspondence between the SCDF and the PTV, and that the truth table is accurate.

Each of the components of the SCDF is tested prior to being included in the SCDF to ensure that they operate properly with one another (e.g., tested during the PTV process). As described in greater detail below, the SCDF can be uploaded to a portion of a main or “mission” computer of the aircraft, and may be stored permanently within the aircraft.

After the software load component has been created (step 110), a user, such as a system administrator, can select a system configuration for the aircraft (step 115). For example, a system administrator can determine the proper system configuration for the aircraft (e.g., a system configuration that is appropriate for a certain mission), and transfer the associated software from the software load component to a portable electronic device (e.g., a portable computer). The SCDF is also transferred to the portable electronic device. This device can then be used by a maintainer to transfer the software to the WRAs in the aircraft, as described in greater detail below. In some embodiments, the system administrator may issue a maintenance work order and only include a single updated software version for one of the WRAs in the aircraft (e.g., the software for each WRA may be installed and/or updated independently of the other WRAs).

After the desired system configuration has been selected by the system administrator, the portable electronic device is ready to load a system configuration into the aircraft (step 120). In some embodiments, a portable electronic device is equipped with an automated software loading program. For example, a maintainer can connect the portable electronic device to the main computer (illustrated as AOP/ASP in the embodiment shown in FIG. 1) of the aircraft to initiate an automated software loading process that loads the software associated with the system configuration from the portable electronic device to the main computer and the WRAs without additional prompts from the maintainer.

In some embodiments, the system configuration must be loaded each time the aircraft is readied for flight. For example, after a military aircraft lands and is shut down, the memory of the main computer, as well as the memories of the WRAs, are cleared for security reasons. Accordingly, prior to flying the aircraft again, the main computer software and the software for the WRAs must be restored (e.g., loaded into the main computer and WRA memories). Prior to loading the software, a maintainer may verify that the memories of the main computer and WRAs are ready to be configured (step 125). The maintainer or pilot can then load the software corresponding to the selected system configuration into the main computer and WRAs (step 125).

The SCDF is preferably permanently stored in an aircraft personality module (“ACPM”) (which may be a portion of the main computer) until the SCDF is updated by a subsequent change to the PTV. The ACPM is generally a permanent component of the aircraft (i.e., it cannot be removed like the WRAs) that can store the SCDF in a non-volatile memory (e.g., read-only memory, flash memory, and the like). Thus, the SCDF can be permanently stored within the ACPM or other memory device. In some embodiments, as described above, the SCDF is a “truth table” (see, for example, FIG. 5) that is permanently stored within the ACPM. For example, after the military aircraft is shut down and the memories of the main computer and WRAs are cleared, the SCDF is allowed to remain. The SCDF can then be used during future flights, without having to be reloaded each time the aircraft is powered up. However, in some embodiments, the SCDF can be updated as new versions of software and new or different components become available.

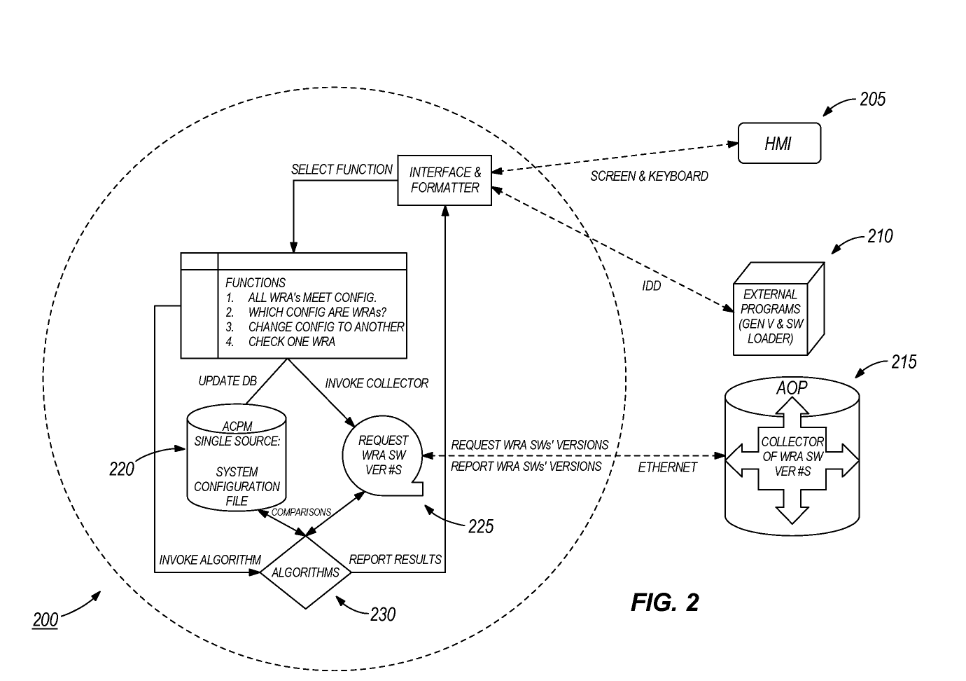

After the SCDF has been stored in the ACPM, the maintainer executes a verification process using, for example, a system configuration utility (e.g., as shown and described with respect to FIG. 2). By executing the verification process, the maintainer (who could be a pilot or flight engineer) can ensure that the appropriate WRAs are installed in the aircraft, and that the software versions that the WRAs are implementing are in accordance with the SCDF. As described in greater detail with respect to FIG. 2, the system configuration utility may execute the verification process by cross referencing the SCDF with the actual software versions that are installed in the WRAs. If all of the installed software versions match those of the SCDF, the aircraft is cleared to launch. If one or more of the installed software versions are not included in the SCDF, the maintainer may have to update the installed software revisions to meet the software revisions included in the SCDF.

In some cases, one or more WRAs or other electronic models may not automatically report their part numbers or installed software version. In these cases, the maintainer will manually read a label affixed to the outside of the WRA or other module that contains the module's part number and software version data. The maintainer or operator then presses a key or otherwise manually marks a check box in the PTV system that indicates he has visually confirmed the software version data for the non-operating modules. The PTV algorithm verifies that the check boxes for the non-reporting modules have been marked before outputting a clear to launch indicator. The list of installed components with respective software version data is a subset of the total list of components actually installed in the system. If one or more modules does not automatically report its part number or software version data, the subset list has fewer entries than the complete list of components actually installed with their actual software version data, and the modules not listed in the automatically-generated list will need to be manually verified. If the automatically-generated list of components includes data for all modules, then the subset list and the complete list of components are the same.

FIG. 2 illustrates a system configuration utility 200 according to an embodiment of the invention. In some embodiments, the system configuration utility 200 shown in FIG. 2 can be utilized during the system configuration management process 100 show in FIG. 1 (see, for example, step 8). For example, the system configuration utility 200 can be used to query an SCDF and determine if the components installed in the aircraft are compatible in accordance with the SCDF.

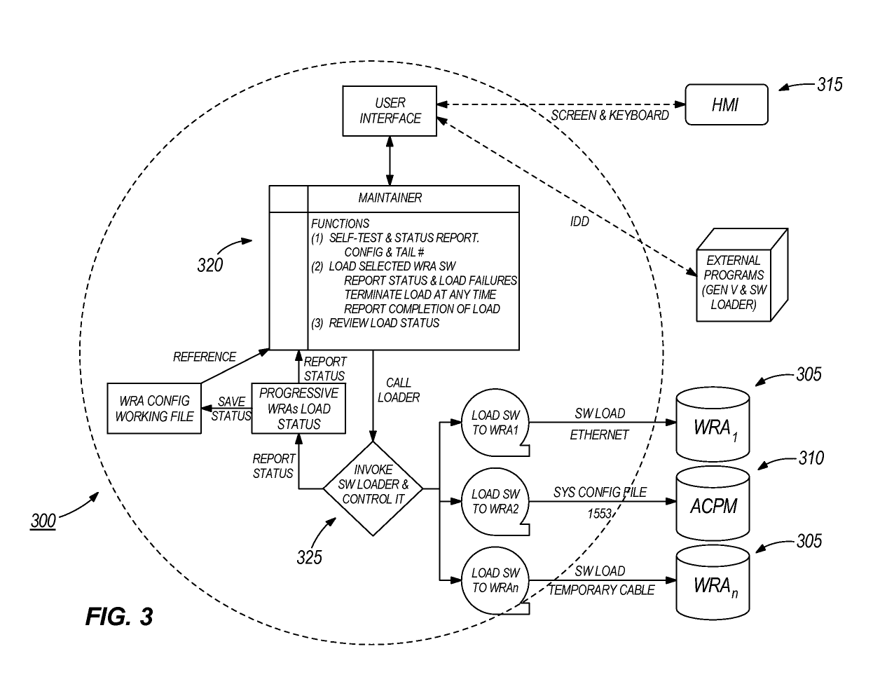

In some embodiments, the system configuration utility 200 is installed in memory of a portable electronic device, such as the portable computer shown in step 120 of FIG. 1. Accordingly, the system configuration utility 200 can interface with various human-machine interfaces (“HMI”) 205 (e.g., a screen, a keyboard, a mouse, etc.), as well as external programs such as other diagnostic and maintenance programs (e.g., a GEN V program by Lockheed Martin Corporation) and a software loader application (see, for example, the software loader application shown and described with respect to FIG. 3). Additionally, the system configuration utility 200 can communicate with other components of the aircraft such as an Avionics Operational Program (“AOP”) 215 that resides in a main computer of the aircraft. In some embodiments, the AOP 215 can communicate with each WRA installed in the aircraft to identify and gain the software revision numbers of each WRA.

As described above, one of the functions of the system configuration utility 200 is to determine if the components installed in the aircraft are allowed according to an SCDF that is stored in an ACPM 220. This can be accomplished by invoking an algorithm 230 to cross reference the SCDF with the WRA software revision numbers (as well as other data) that are requested and received by a WRA request module 225.

A user (e.g., a pilot) of the system configuration utility 200 may implement the system configuration utility 200 by initializing or launching the utility (e.g., using a pilot interface, as shown, for example, by FIG. 9). Alternatively, a maintainer may implement the system configuration utility 200 using a portable computer. The user can then select one of four or more functions. For example, the user can choose to verify that all WRAs meet a system configuration (using, for example, the SCDF), verify the configuration (e.g., make, model, software version, etc.) of a WRA, change from one system configuration to a different system configuration, or verify that a single, selected WRA meets a system configuration.

After the user makes a functional selection, the system configuration utility 200 opens the SCDF from a storage device within the ACPM 220. The system configuration utility 200 then queries the aircraft's WRAs (e.g., using the request module 225, as described above) to obtain their individual software version numbers. Next, the system configuration utility 200 invokes an algorithm 230 to compare the contents of the SCDF with the WRAs' software version numbers. In some embodiments, other data, such as the make and model number, the device number, and/or the manufacturer part numbers of the WRAs are also compared to the contents of the SCDF. The system configuration utility 200 then reports the results of the algorithm 230 to the user. For example, the system configuration utility 200 may indicate that all WRAs meet the SCDF (e.g., it is OK to fly), that some of the WRAs do not meet the SCDF (e.g., it is not OK to fly), or that there is a problem with one or more of the software programs (e.g., it is not OK to fly). These results can be reported via the HMI 205.

FIG. 3 illustrates a software loader application 300 according to an embodiment of the invention. In some embodiments, the software loader application 300 shown in FIG. 3 can be utilized during the system configuration management process 100 show in FIG. 1 (see, for example, steps 6 and 7). For example, as described in greater detail below, the software loader application 300 can be used to load software into WRAs 305 installed in an aircraft. Additionally, the software loader application 300 can be used to store an SCDF into an ACPM 310.

In some embodiments, similar to the system configuration utility 200 shown in FIG. 2, the software loader application 300 is installed in memory of a portable computer, such as the portable computer shown in FIG. 1, which can be interfaced with the main computer of the aircraft. In other embodiments, the software loader application 300 is stored in the main computer. The software loader application 300 is generally utilized after a maintainer has prepared a portable PC (using HMI 315) with files that are to be loaded onto the ACPM and WRAs of the aircraft. Next, the maintainer executes a system configuration utility (e.g., the system configuration utility 200 shown in FIG. 2) to verify the initial aircraft's current system configuration. For example, the maintainer can execute the system configuration utility to ensure that the memories of the main computer and WRAs are clear and ready to be loaded with software. If the system configuration is correct, the software loader application is used to carry out one or more loading functions. For example, upon launching the software loader application 300, the maintainer can choose to execute one or more functions 320. One function of the software loader application 300 is a self-test and status report. Another function is a software loading process that loads software on to one or more WRAs, and reports the status of the loading. For example, the software loader application 300 may report software loading failures, or report the completion of the software loading process. This loading process can be initialized using a loading module 325, which is in communication with each of the WRAs 305 and the ACPM 310. The software loader application 300 can also terminate the software loading process at any time. Another software loading function 320 is to review the load status. For example, after the software loading process has been completed for all of the WRAs of the aircraft, the software loader application 300 can be used to review the WRAs that received software, and if the software was loaded properly.

In some embodiments, in addition to loading software into the WRAs, the software loader application 300 can be used to transmit and store a SCDF in the ACPM 310 of the aircraft. As described above, the SCDF can be used to verify that the components installed in the aircraft and their software versions are compliant with the SCDF. Accordingly, the system configuration utility 300 can then be initialized to verify that the aircraft's system configuration is correct.

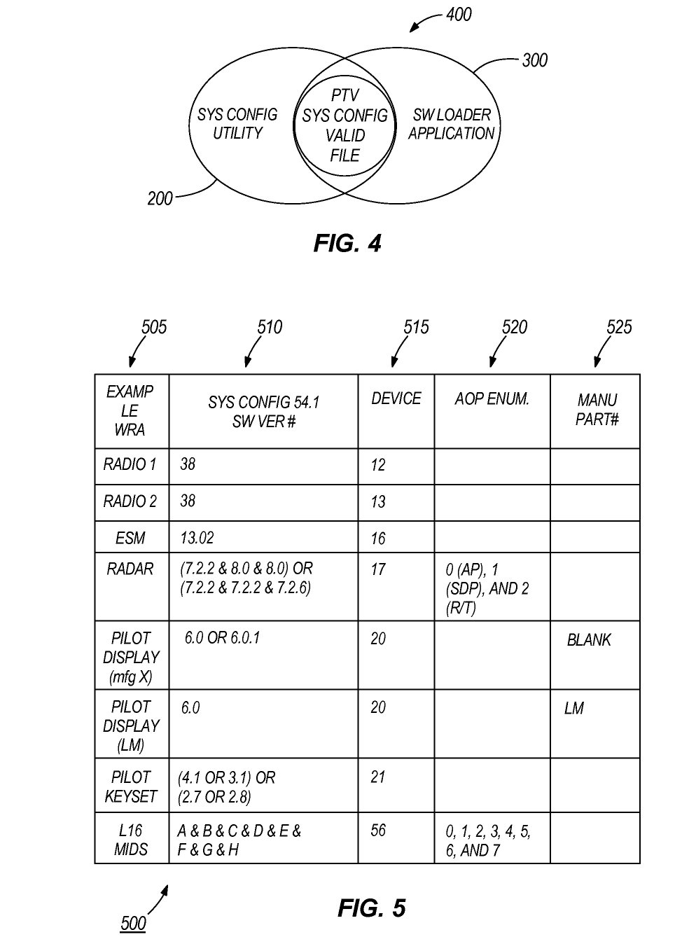

FIG. 4 illustrates a relationship 400 between the system configuration utility 200 shown in FIG. 2 and the software loader application 300 shown in FIG. 3. For example, while the system configuration utility 200 and the software loader application 300 are independent components, they share, or utilize, an SCDF 400. As described above, the software loader application 300 can be used to store the SCDF in the ACPM of the aircraft. The system configuration utility 200 can be used to verify that the components installed in the aircraft comply with the SCDF.

FIG. 5 illustrates a truth or look-up table 500 according to an embodiment of the invention. In some embodiments, the truth table 500 is included in an SCDF. For example, for a certain system configuration (e.g., system configuration 54.1), the truth table 500 includes configuration data for each WRA included in the system configuration, which must be verified (e.g., verified with the WRAs installed in the aircraft). The number of WRA parameters that are included in the truth table 500 is scaleable. For example, in some embodiments, a single WRA parameter is verified (e.g., allowed software version numbers). In other embodiments, as described below, additional WRA parameters are added to the table 500 and verified. In the embodiment shown in FIG. 5, the truth table 500 includes a WRA column 505, a software version number column 510, a device number column 515, an enumeration column 520, and a manufacturer part number column 525.

The WRA column 505 provides the name and/or type of WRA included in the system configuration. For example, in the embodiment shown in FIG. 5, a first radio, a second radio, an electronic support measures (“ESM”) device, a radar device, a first pilot display, a second pilot display, a pilot keyset, and a Multifunctional Information Distribution System (“MIDS”) are included in the system configuration. An alternative system configuration may include more or fewer WRAs in the WRA column 505.

The software version number column 510 provides a listing of supported software version or revision numbers. As shown in FIG. 5, in some embodiments, more than one version number is valid or allowed for some of the WRAs. Accordingly, each valid software version numbers is listed. In some embodiments, the software version number column 510 is updated as new software versions are tested and implemented. For example, a radar device may be updated with a newer software version or revision. Accordingly, the new software version number must be added to the software version number column 510 after it is tested (e.g., tested during a PTV) and added to the system configuration (see, for example, step 1 shown in FIG. 1). In some embodiments, each software version number included in the truth table 500 must match the software versions of the WRAs for the system configuration to be correct.

The device number column 515 provides data related to device numbers of the WRAs. Each of the WRAs is assigned a device number, which can be used to locate the device in the aircraft. The AOP Enumeration column 520 provides the number assigned to the specific software program in a single WRA or LRU. For example, if a WRA has eight programs, they would be assigned numbers from 0 through 7. Each program in each LRU/WRA must have its compatibility checked separately.

The manufacturer part number column 525 provides data related to the part numbers of the WRAs. The manufacturer part numbers are generally assigned to the WRAs during manufacture, and are not changed.

In other embodiments, the truth table 500 may include more or fewer columns (and corresponding data) than those shown in FIG. 5. For example, in some embodiments, the truth table 500 may also include a date parameter that provides data related to the date that the WRA was last installed in an aircraft. Additionally or alternatively, the truth table 500 may include a date parameter that provides data related to the time and/or date that the software version of the WRA was last updated. The truth table 500 may also include a communication or data transmission parameter (e.g., CAT5, USB 2.0, IEEE 1394, RJ-45, and the like) that is verified. In other embodiments, the truth table 500 may include only a subset of the data shown in the columns included in the table 500. Thus, the truth table 500 can be expanded from 1 to “n” columns (and corresponding identifiable parameters) that are verified.

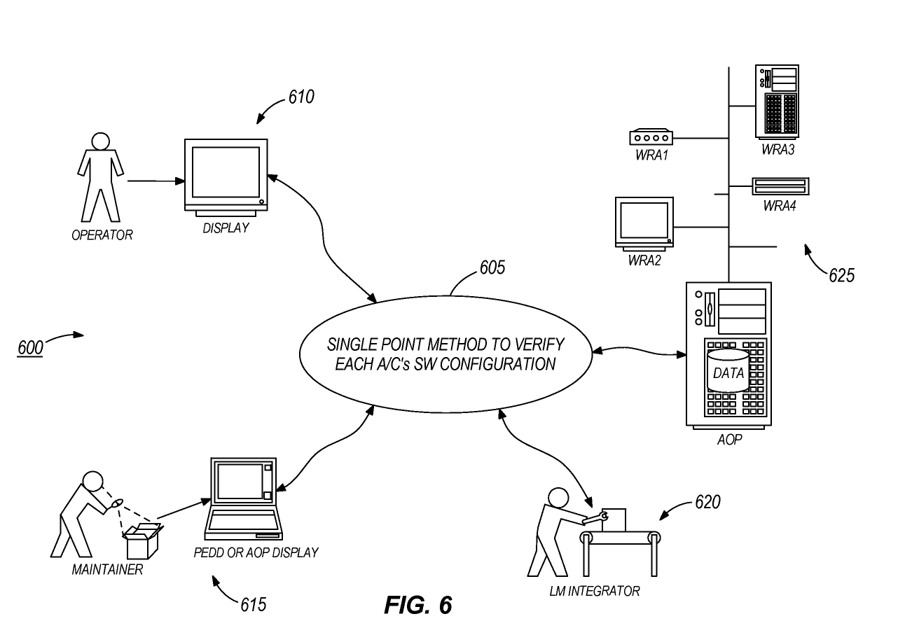

FIG. 6 illustrates a relationship 600 between a variety of “users” and a system configuration management process 605. As shown in FIG. 6, an operator (e.g., a pilot) 610, a maintainer (e.g., a mechanic, a technician, and/or a system administrator) 615, and an integrator (e.g., a software supplier) 620 can use the configuration management process 605 to perform tasks related to the system configuration of an aircraft (and its associated components) 625. For example, as described in detail above, the operator 610 can use the configuration management process 605 to verify that the WRAs installed in the aircraft 625 are certified as compatible for a certain system configuration prior to a flight. The maintainer 615 can use the configuration management process 605 to verify that WRA software is compatible to a valid system configuration prior to installing and/or changing the WRAs in the aircraft 625 (or updating the software of the WRAs). Additionally, the maintainer 615 can use the configuration management process 605 to find the closest applicable system configuration for a certain set of WRAs (e.g., a system configuration that includes two radios, an ESM, radar, a pilot display, and a pilot keyset). The maintainer 615 can also use the configuration management process 605 to change from one system configuration system to another system configuration (e.g., change to a system configuration with an alternative set of WRAs). The maintainer 615 can also use the configuration management process 605 to verify that a single WRA meets a valid system configuration. The integrator 620 is involved in the configuration management process 600 to assemble and provide valid SCDFs, as well as the software for the WRAs. The integrator must first test the components and software (e.g., during a PTV process) to ensure that the system configurations are valid prior to providing the SCDFs and software to another user (such as the maintainer 615).

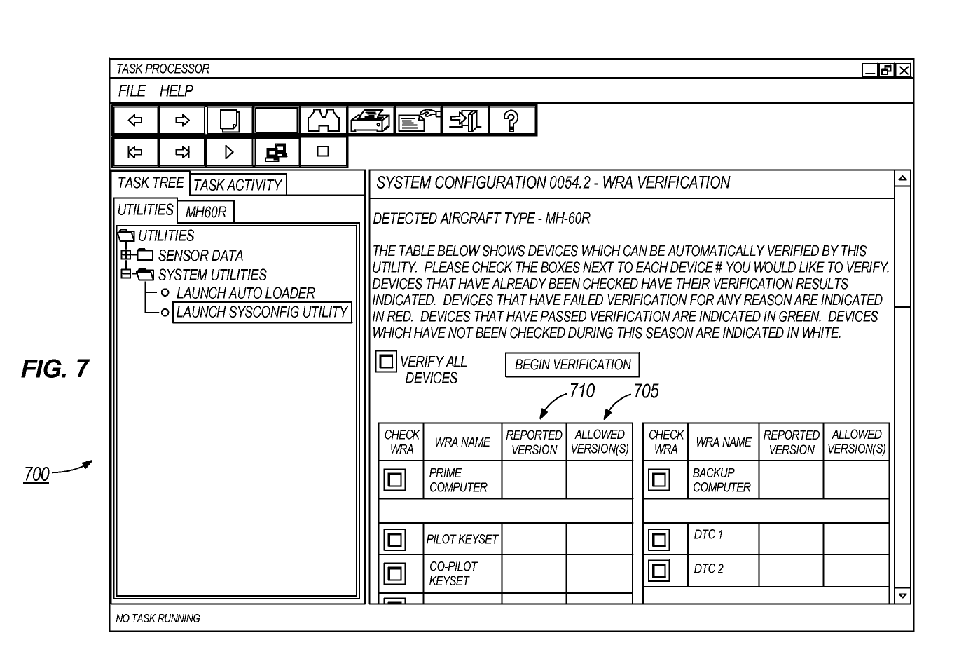

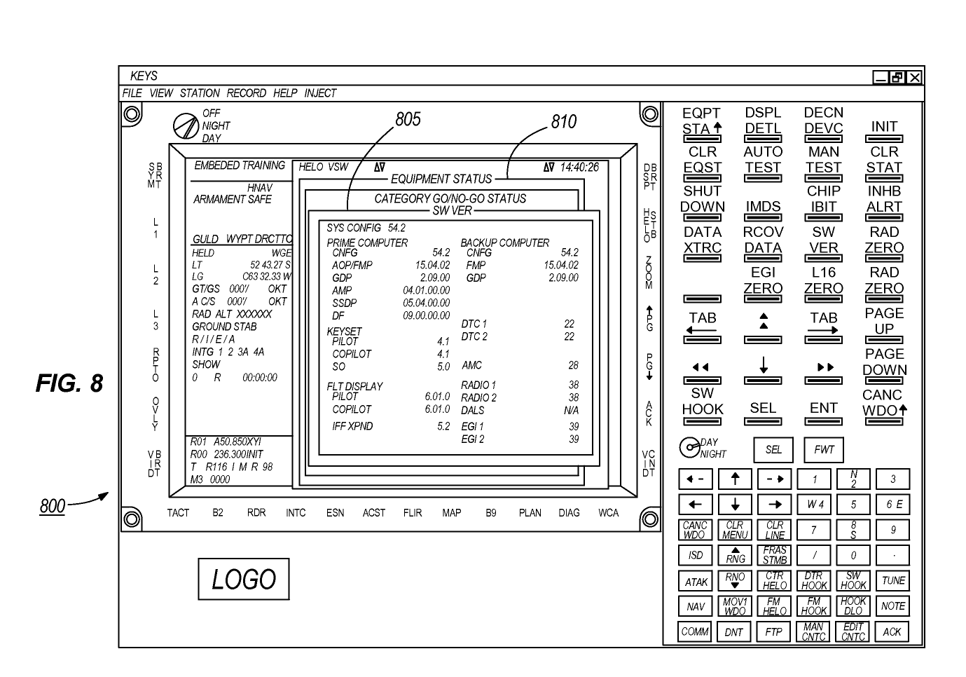

FIG. 7 illustrates a diagnostic tool 700 that can be used to diagnose and provide maintenance instructions for an aircraft. In the embodiment shown in FIG. 7, the diagnostic tool is a GEN V Task Processor available from Lockheed Martin Corporation. In other embodiments, an alternative type of diagnostic tool may be used. As shown in FIG. 7, a system configuration utility (such as the system configuration utility 200 shown in FIG. 2), as well as a software auto-loading utility (such as the loader module 325 of the software loader application 300 shown in FIG. 3) can be launched using the diagnostic tool 700. Accordingly, the results of a system configuration verification process can be displayed using the diagnostic tool. For example, each component 705 that is installed in the aircraft can be displayed, along with allowed versions of software 710 for those components. After the verification process is completed, actual or reported versions of software 715 are also displayed. A maintainer can then verify that the version of software that is installed in the WRAs is one of the allowed versions.

FIG. 8 illustrates a display 800 that may be installed in an aircraft. Similar to the embodiment shown in FIG. 7, the display 800 may be used to display the software versions of the software that is installed in the WRAs of the aircraft, as well as the results of a system configuration verification process. For example, the display 800 includes a first window 805 that lists the WRAs and corresponding software versions. The display 800 also includes a second window 810 that lists the status of the WRAs after the system configuration verification process has been completed (e.g., an equipment status screen). In some embodiments, the status of the WRAs is listed as “GO,” indicating that the installed software version matches the version included in an SCDF, or “NO GO,” indicating that the installed software version does not match the version included in the SCDF. In other embodiments, the status may also indicate the installed software version number and the allowed software version number(s).

As discussed above in connection with FIG. 1, if a WRA or other module does not report its part number or actual software version data, the missing data must be manually confirmed by the maintainer or operator.

The embodiments described with respect to FIGS. 1-9 were directed to an aircraft system. However, as should be apparent to one of ordinary skill in the art, a system configuration process (and associated system verification process) can be implemented in a variety of applications. For example, trucks High Mobility Multipurpose Wheeled Vehicle (HMMWV) or STRYKER vehicles may implement a variety of electronic components (e.g., a radio or other communication system, one or more radar systems, a weapons system, etc.), each of which include software that may have several versions. In such embodiments, the system configuration process can be used to verify the software versions that are being used by the electronic components. Additionally, the system configuration process can be used to verify that the components will work properly with each other. The system configuration process can also be implemented in other vehicles and/or equipment. Many passenger vehicles (cars and trucks) implement a variety of inter-related controllers (e.g., an airbag controller, a traction control system controller, an engine controller, etc.) that implement software. This software can be updated, for example, during maintenance or enhancement events (e.g., a performance chip is added to an engine controller to boost horsepower). Accordingly, the system configuration process could be used to verify that the software versions are valid for a particular system configuration. Additionally, machinery (e.g., a front-end loader, an excavator, etc.) may also implement a variety of inter-related controllers (e.g., a hydraulic controller, an engine controller, etc.), and thus, could benefit from the system configuration process.

In other embodiments, the system configuration process can be used in non-vehicle related applications. For example, the system configuration process may be used to verify the electronic components implemented in an air traffic control station (e.g., a variety of radios and other communication devices, radar systems, and other computing systems). These electronic components may be upgraded, removed, and/or replaced by other components, and thus, can benefit from a system configuration process that verifies that the electronic components (and their software) are compatible. The system configuration process can also be implemented in a manufacturing setting that implements motor drives, programmable logic controllers (“PLCs”), vibration sensing systems, and the like, which interact with each other. Accordingly, the system configuration process can be used to verify that the software implemented by each of the devices are compatible. Other applications will also be apparent to administrators of complex software systems having many software modules.

1. A method of implementing a test verification of a system configuration within a system having a plurality of installed components, comprising:
providing a system configuration definition that includes both a list of installed components in the system and the corresponding respective installed software version data that should be implemented by each of the installed components;
determining, for a subset of the installed components, the installed software version actually installed in the system; and
comparing the installed software version data for the subset of installed components with the system configuration definition to verify that the installed software version of each installed component in the subset is in the system configuration definition.

2. The method of claim 1, further comprising: storing the system configuration definition in a permanent memory of the system.

3. The method of claim 1, further comprising: outputting the results of the comparison to an output device, wherein the output device provides at least one of an audible and visual indicator of the comparison between the installed software version and the system configuration definition.

4. The method of claim 1, further comprising: loading the software version data for at least one installed component of the system, wherein the software version data is in the system configuration definition.

5. The method of claim 1, further comprising: outputting the list of the installed components and respective software version data installed on the system to an output device, wherein the output device is at least one of a display screen, a printer and an electronic file.

6. The method of claim 1, further comprising: transferring software version data to the system for at least one installed component of the system.

7. The method of claim 1, further comprising: transferring software version data from a portable electronic device to the system for at least one of the installed components of the system.

8. The method of claim 1, further comprising: selecting the system configuration appropriate for a given task.

9. The method of claim 1, further comprising: storing the system configuration definition in a non-volatile memory of an aircraft personality module.

10. The method of claim 1 wherein the system includes an aircraft, further comprising: clearing the aircraft to launch by verifying that all of the software versions of the installed components correspond to the respective installed software version data of the system configuration definition.

11. The method of claim 1 wherein the system configuration definition is installed in a memory of a portable electronic device, and further comprising: interfacing the system configuration definition with at least one human-machine interface.

12. The method of claim 1, further comprising: interfacing the system configuration definition with at least one external program, wherein the external program is at least one of a diagnostic and a maintenance program.

13. The method of claim 1, wherein the system includes an aircraft having other components, the method further comprising: interfacing the system configuration definition with the other components of the aircraft.

14. The method of claim 1, further comprising: comparing a make and model number of each of the installed components with the system configuration definition.

15. The method of claim 1, further comprising: transmitting the system configuration definition from a software loader application to the system.

16. The method of claim 1, further comprising: manually verifying the actual installed software version for installed components which are not in the subset of installed components.

17. The method of claim 1, further comprising: generating data corresponding to the system configuration definition while implementing the test verification.

18. Apparatus configured to verify that a subset of installed components implemented in a selected system includes compatible software versions, comprising:
a memory device;
a system configuration definition, stored in the memory device, including a list of the components in the subset and the corresponding respective installed software version data that are implemented by the respective components in the subset;
a processor connected in circuit to each subset component and to the memory device, the processor being configured to:
query each subset component to determine the installed software version data loaded on the respective subset component; and
compare the installed software version data for each component in the subset with the system configuration definition to verify that the installed software version data for each component in the subset is in the system configuration definition.

19. The apparatus of claim 18, wherein the processor is further configured to:
run an algorithm to compare the installed software version data for each component in the subset with the system configuration definition.

20. The apparatus of claim 18, further comprising:
an output device which receives at least one of an audible and a visual indicator indicating the results of comparison between the installed software version data for each subset component and the system configuration definition.

21. The system of claim 20, wherein the output device is at least one of a display, a printer and an electronic file.

22. The apparatus of claim 18, wherein the processor is further configured to:
transmit an output signal to an output device, wherein the signal comprises at least one of an audible and visual indicator of the results of comparison between the installed software version data for each component and the system configuration definition.

23. The apparatus of claim 18, wherein the system configuration definition further comprises a list of the manufacturers of each component of the selected system.

24. The apparatus of claim 18, further comprising a portable electronic device including a memory that stores the system configuration definition.

25. The apparatus of claim 18, further comprising an aircraft personality module comprising the system configuration definition.

26. The apparatus of claim 18, wherein the processor is further configured to:
interface with at least one human-machine interface.

27. The apparatus of claim 18, wherein the processor is further configured to:
interface with an external program or a software loader application.

28. The apparatus of claim 18, further comprising a software loader application, wherein the software loader application is configured to transmit the system configuration definition.

29. The apparatus of claim 18, wherein the system configuration definition comprises a truth table.

30. The apparatus of claim 29, wherein the truth table comprises software version data for each subset component in the selected system.

31. The apparatus of claim 18, wherein the processor is further configured to:
verify at least one parameter of the selected system, wherein the at least one parameter of the selected system is selected from a group comprising a list of installed components, software versions, component device number, and manufacturer part number.

32. The apparatus of claim 18, further comprising a diagnostic tool.

33. The apparatus of claim 18, further comprising an output device, wherein the output device is configured to display a list of the installed software version data.

34. The apparatus of claim 18, wherein the memory device is configured to permanently store the system configuration definition.

35. The apparatus of claim 18, wherein the processor is further configured to:
generate data corresponding to the system configuration definition.
